(19) United States
(12) Patent Application Publication
(10) Pub. No.: US 2017/0027195 A1
(43) Pub. Date: Feb. 2, 2017

(54) Drinking Water with Nutrients

(71) Applicants: Cortez Hollis, Mankato, MN (US); Marcus Thigpen, Mankato, MN (US)

(72) Inventors: Cortez Hollis, Mankato, MN (US); Marcus Thigpen, Mankato, MN (US)

(21) Appl. No.: 15/224,420

(22) Filed: Jul. 29, 2016

Related U.S. Application Data
(60) Provisional application No. 62/198,154, filed on Jul. 29, 2015.

(51) Int. Cl. A23L 2/56; A23L 2/52; A23L 2/38

(52) U.S. Cl. CPC A23L 2/56; A23L 2/38; A23L 2/52; A23V 2002/00

(57) ABSTRACT

Drinking water with nutrients contains vitamins, minerals and amino acids to replenish the body and build muscle mass. The water is bottled in single servings, in an hourglass-shaped bottle to facilitate a secure grip despite such problems as perspiration and condensation, and is similar in most respects to electrolyte waters, such as Gatorade®.

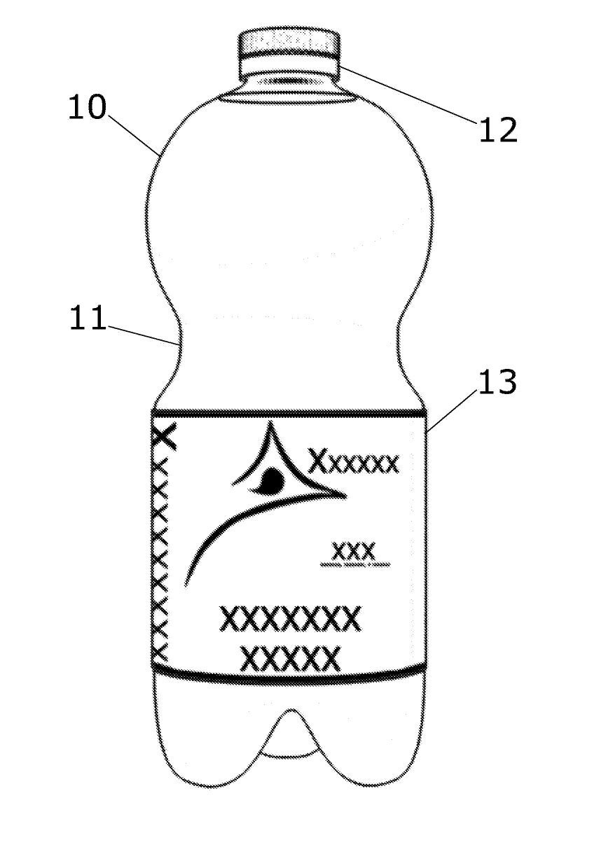

### CROSS-REFERENCE TO RELATED APPLICATIONS

This Application claims the benefit of U.S. Provisional Application No. 62/198,154, filed Jul. 29, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to health foods and beverages, and in particular to drinking water with nutrients. Weightlifters and other athletes who focus on the development of muscle mass have been consuming protein shakes for many years. Unfortunately, protein shakes fail to quench the athlete's thirst or replenish lost electrolytes, which is the main purpose of other types of beverages for active people. Aside from the problems inherent in carrying and storing two different types of beverages, the athlete may simply be incapable of ingesting enough protein shakes and enough electrolyte water to satisfy training goals. A single beverage which can combine the functions of a protein shake and electrolyte water would be well received. Drinking water with nutrients, which provides both amino acids to build muscle tissue and electrolytes to replenish the body during or after a workout, would resolve these problems.

### SUMMARY OF THE INVENTION

Accordingly, the invention is directed to drinking water with nutrients. The water is bottled in single servings, in an hourglass-shaped bottle to facilitate a secure grip despite such problems as perspiration and condensation, and is similar in most respects to electrolyte waters, such as Gatorade®. Additionally, the water contains vitamins, minerals, and amino acids to build muscle mass, in a manner similar to a protein shake.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

The FIGURE shows a front view of the first exemplary embodiment in a single serving bottle, displaying the bottle 10, the tapering point 11, the cap 12, and the label 13.

### DETAILED DESCRIPTION OF THE INVENTION

Referring now to the invention in more detail, the invention is directed to drinking water with nutrients.

The first exemplary embodiment is comprised of a water solution which is bottled in single servings, in an hourglass-shaped bottle 10 with a tapering point 11 at the center of mass to facilitate a secure grip by the user on the surface of the bottle 10, despite such problems as perspiration and condensation. Preferably, the bottle 10 provides a threaded cap 12 and a label 13, and is provided in such single-user sizes as 12-ounce and 1-liter. Larger sizes, for use by sports teams such as football and basketball teams, are contemplated.

The formulation of the water solution is similar in most respects to electrolyte waters, such as Gatorade®. Additionally, the water solution contains vitamins, minerals, and amino acids to build muscle mass, in a manner similar to a protein shake. The water solution may also contain various flavorings, such as fruit punch or lemonade flavorings.

Electrolytes provided by the beverage preferably include sodium, chloride, potassium, bicarbonate, and phosphate. These are lost in large quantities through perspiration during an intense workout, and are required to keep muscles and nerves functioning properly. Preferably, the formulation includes a small amount of glucose to facilitate absorption of the water and electrolytes.

A full range of amino acids is also provided to prevent muscle breakdown during a workout, promote muscle recovery after the workout, and promote the growth of muscle tissue. The water solution may also include creatine, which improves the user's energy level and endurance, and promotes the development of muscle size and strength.

To use the first exemplary embodiment, the user may twist off the cap 12 from the bottle 10, grasp the bottle 10 securely at the tapering point 12, and drink the contents whenever they need to hydrate. This includes but is not limited to during and after a workout. The user may drink the contents anytime they wish to hydrate.

The bottle 10 and the cap 12 are preferably manufactured from a rigid, durable material, such as plastic. The label 13 is preferably manufactured from a flexible, durable material, such as paper or plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A drinking water solution, comprising: a water solution; said water solution containing electrolytes, vitamins, minerals, and amino acids.

2. The drinking water solution of claim 1, wherein said electrolytes include at least one of: sodium, chloride, potassium, bicarbonate, and phosphate.

3. The drinking water solution of claim 1, wherein said water solution further contains a small amount of glucose such that the water solution and electrolytes are more easily absorbed when drank.

4. The drinking water solution of claim 1, wherein said water solution further contains creatine.

5. The drinking water solution of claim 1, wherein said water solution is provided in a bottle; said bottle providing a cap; said bottle having an hourglass shape with a tapering point at the center of mass.

6. The drinking water solution of claim 5, wherein said electrolytes include at least one of: sodium, chloride, potassium, bicarbonate, and phosphate.

7. The drinking water solution of claim 5, wherein said water solution further contains a small amount of glucose such that the water solution and electrolytes are more easily absorbed when drank.

8. The drinking water solution of claim 5, wherein said water solution further contains creatine.

9. The drinking water solution of claim 5, wherein said cap is a threaded cap.

10. The drinking water solution of claim 5, wherein said bottle further provides a label.

11. The drinking water solution of claim 5, wherein said bottle is provided in a twelve-ounce size.

12. The drinking water solution of claim 5, wherein said bottle is provided in a one-liter size.

13. The drinking water solution of claim 1, wherein said water solution further contains flavoring.

14. The drinking water solution of claim 5, wherein said water solution further contains flavoring.
